(19) United States
(12) Patent Application Publication
(10) Pub. No.: US 2018/0355150 A1
(43) Pub. Date: Dec. 13, 2018

(54) LIQUID CRYSTAL POLYESTER COMPOSITION AND MOLDED ARTICLE

(71) Applicant: Sumitomo Chemical Company, Limited, Tokyo (JP)

(72) Inventor: Kyungbae KIM, Pyeongtaek-si (KR)

(73) Assignee: Sumitomo Chemical Company, Limited, Tokyo (JP)

(21) Appl. No.: 15/781,763

(22) PCT Filed: Dec. 7, 2016
(86) PCT No.: PCT/JP2016/086349

§ 371 Date: Jun. 6, 2018

(30) Foreign Application Priority Data
Dec. 9, 2015 (JP) 2015-240454

(51) Int. Cl. C08K 7/14; C08G 63/60; C08J 3/20; C08K 3/40; C08K 3/34; H01R 12/70

(52) U.S. Cl. CPC C08K 7/14; C08G 63/605; C08J 3/201; C08K 3/40; C08K 2201/003; H01R 12/7076; C08G 2250/00; C08K 2003/343; C08K 3/34

(57) ABSTRACT

A liquid crystal polyester composition containing a liquid crystal polyester and a glass fiber is provided. The amount of the glass fiber is at least 10 parts by mass but not more than 70 parts by mass per 100 parts by mass of the liquid crystal polyester, and the glass fiber contains a glass fiber (1) having a number average fiber diameter of at least 15 μm but not more than 25 μm and a glass fiber (2) having a number average fiber diameter of at least 10 μm but not more than 12 μm.

### TECHNICAL FIELD

The present invention relates to a liquid crystal polyester composition and a molded article.

Priority is claimed on Japanese Patent Application No. 2015-240454, filed Dec. 9, 2015, the content of which is incorporated herein by reference.

### BACKGROUND ART

One known example of an electronic component connector is a CPU socket which is used for detachably mounting a CPU (central processing unit) to an electronic circuit board. A liquid crystal polyester resin having excellent heat resistance and the like is employed as the molding material for forming the CPU socket.

As electronic equipment has increased in performance and the like, the circuit scale of CPUs mounted on electronic circuit boards has also increased. In general, as the scale of CPUs increases, the number of connection pins also increases. In recent years, CPUs having about 700 to 1,000 connection pins have become known. The CPU connection pins are arranged on the bottom surface of the CPU, for example in a matrix-like arrangement. If the size of the CPU remains constant, then the pitch between these connection pins tends to narrow as the number of connection pins increases.

A CPU socket has a plurality of pin insertion holes, which correspond with each of the connection pins of the CPU and form a lattice. As the pitch between the connection pins narrows, the pitch between the pin insertion holes also narrows, and the resin portions that separate adjacent pin insertion holes, namely the lattice walls, become thinner. As a result, in a CPU socket, the greater the number of pin insertion holes, the more likely it becomes that stress during reflow mounting or pin insertion or the like may act upon these walls, with this stress causing damage to the lattice (hereinafter also referred to as cracking).

In this manner, electronic component connectors such as CPU sockets require an improvement in the resistance to post-molding cracking.

Conventionally, liquid crystal polyester compositions containing a fibrous filler added to the liquid crystal polyester are known to improve the mechanical strength of molded articles.

For example, Patent Document 1 discloses a reinforced liquid crystal resin composition obtained by adding at least 5 parts by weight but not more than 200 parts by weight of a combination of a glass fiber having an average fiber diameter of at least 3 μm but less than 10 μm and a glass fiber having an average fiber diameter of at least 10 μm but less than 20 μm per 100 parts by weight of a prescribed liquid crystal polyester resin.

### PRIOR ART LITERATURE

### Patent Document

Patent Document 1: JP H03-243648-A

### SUMMARY OF INVENTION

### Problems to be Solved by the Invention

Even the liquid crystal polyester composition disclosed in the above Patent Document 1 does not exhibit entirely satisfactory resistance to post-molding cracking of the molded articles such as CPU sockets, and further improvement is required.

The present invention has been developed in light of these circumstances, and has an object of providing a liquid crystal polyester composition which, when molded to form a molded article, not only improves the resistance to cracking in the molded article, but can also suppress warping of the molded article. Further, the present invention also has the object of providing a molded article molded from this type of liquid crystal polyester composition.

### Means for Solving the Problems

A first aspect of the present invention provides a liquid crystal polyester composition comprising a liquid crystal polyester and a glass fiber, wherein the amount of the glass fiber is at least 10 parts by mass but not more than 70 parts by mass per 100 parts by mass of the liquid crystal polyester, and the glass fiber comprises a glass fiber (1) having a number average fiber diameter of at least 15 μm but not more than 25 μm and a glass fiber (2) having a number average fiber diameter of at least 10 μm but not more than 12 μm.

A second aspect of the present invention provides a molded article obtained by molding the liquid crystal polyester composition of the first aspect.

The molded article of the second aspect of the present invention is preferably a connector.

The above connector is preferably a CPU socket.

In other words, the present invention includes the following aspects.
[1] A liquid crystal polyester composition comprising a liquid crystal polyester and a glass fiber, wherein

the amount of the glass fiber is at least 10 parts by mass but not more than 70 parts by mass per 100 parts by mass of the liquid crystal polyester, and

the glass fiber comprises a glass fiber (1) having a number average fiber diameter of at least 15 μm but not more than 25 μm and a glass fiber (2) having a number average fiber diameter of at least 10 μm but not more than 12 μm.
[2] The liquid crystal polyester composition according to [1], wherein the ratio between the amount of the glass fiber (1) and the amount of the glass fiber (2), when represented by [amount of glass fiber (1)]/[amount of glass fiber (2)] (parts by mass/parts by mass), is from 1/1 to 1/4.
[3] The liquid crystal polyester composition according to [1] or [2], wherein the liquid crystal polyester comprises a repeating unit represented by formula (1), a repeating unit represented by formula (2), and a repeating unit represented by formula (3).

—O—Ar¹—CO— (1)

—CO—Ar²—CO— (2)

—X—Ar³—Y— (3)

(In formula (1) to formula (3), Ar¹ represents a phenylene group, a naphthylene group, or a biphenylylene group;

each of Ar² and Ar³ independently represents a phenylene group, a naphthylene group, a biphenylylene group, or a group represented by formula (4);

each of X and Y independently represents an oxygen atom or an imino group; and

hydrogen atoms in a group represented by Ar¹, Ar² or Ar³ may each be independently substituted with a halogen atom, an alkyl group of 1 to 10 carbon atoms or an aryl group of 6 to 20 carbon atoms.)

—Ar⁴—Z—Ar⁵— (4)

(In formula (4), each of Ar⁴ and Ar⁵ independently represents a phenylene group or a naphthylene group; and Z represents an oxygen atom, sulfur atom, carbonyl group, sulfonyl group or alkylidene group of 1 to 10 carbon atoms.)
[4] A molded article molded from the liquid crystal polyester composition according to any one of [1] to [3].
[5] The molded article according to [4], wherein the molded article is a connector.
[6] The molded article according to [5], wherein the connector is a CPU socket.

### Effects of the Invention

The present invention can provide a liquid crystal polyester composition which, when molded to form a molded article, not only improves the resistance to cracking in the molded article, but can also suppress warping of the molded article. Further, the present invention can also provide a molded article molded from this type of liquid crystal polyester composition.

### BRIEF DESCRIPTION OF THE DRAWINGS

FIG. 1A is a schematic plan view illustrating a connector according to the present invention.

FIG. 1B is a cross-sectional view along the line A-A in FIG. 1A.

FIG. 2 is a schematic plan view illustrating a connector according to the present invention, and represents an enlarged view of the region B in FIG. 1A.

### EMBODIMENTS FOR CARRYING OUT THE INVENTION

### <Liquid Crystal Polyester Composition>

A liquid crystal polyester composition that represents a first aspect of the present invention comprises a liquid crystal polyester and a glass fiber, wherein the amount of the glass fiber is at least 10 parts by mass but not more than 70 parts by mass per 100 parts by mass of the liquid crystal polyester, and the glass fiber comprises a glass fiber (1) having a number average fiber diameter of at least 15 μm but not more than 25 μm and a glass fiber (2) having a number average fiber diameter of at least 10 μm but not more than 12 μm.

Because the liquid crystal polyester composition comprises a combination of the glass fiber (1) and the glass fiber (2), a molded article obtained by molding the liquid crystal polyester composition is resistant to deformation under high-temperature conditions (for example, the 200 to 250° C. that represents the temperature used during reflow heating). As a result, a molded article obtained by molding the liquid crystal polyester composition of the present invention has improved resistance to cracking, meaning the occurrence of cracking can be suppressed. Further, by using a combination of the glass fiber (1) and the glass fiber (2), the fluidity of the liquid crystal polyester composition improves, and therefore the filling properties of the liquid crystal polyester composition improve. As a result, in a molded article molded from the liquid crystal polyester composition, warping of the molded article can be reduced.

The liquid crystal polyester composition may be obtained by mixing together the liquid crystal polyester and the glass fibers (namely, a mixture of powders), or may be obtained by melt kneading of the various components, and for example, processing into a pellet-like form.

### «Liquid Crystal Polyester»

One embodiment of the liquid crystal polyester according to the present invention is described below.

The liquid crystal polyester according to one embodiment of the present invention may be a liquid crystal polyester, a liquid crystal polyester amide, a liquid crystal polyester ether, a liquid crystal polyester carbonate, or a liquid crystal polyester imide. The liquid crystal polyester according to the present invention is preferably a fully aromatic liquid crystal polyester obtained by polymerizing only aromatic compounds as the raw material monomers.

Typical examples of the liquid crystal polyester according to the present invention include: those obtained by polymerizing (polycondensing) an aromatic hydroxycarboxylic acid, an aromatic dicarboxylic acid, and at least one compound selected from the group consisting of aromatic diols, aromatic hydroxyamines and aromatic diamines; those obtained by polymerizing a plurality of aromatic hydroxycarboxylic acids; those obtained by polymerizing an aromatic dicarboxylic acid and at least one compound selected from the group consisting of aromatic diols, aromatic hydroxyamines and aromatic diamines; and those obtained by polymerizing a polyester such as polyethylene terephthalate and an aromatic hydroxycarboxylic acid. Here, each of the aromatic hydroxycarboxylic acids, aromatic dicarboxylic acids, aromatic diols, aromatic hydroxyamines and aromatic diamines may, independently, be partially or completely replaced with a polymerizable derivative of one of these compounds.

Examples of polymerizable derivatives of the compounds having a carboxyl group such as the aromatic hydroxycarboxylic acids and aromatic dicarboxylic acids include compounds in which the carboxyl group has been converted to an alkoxycarbonyl group or an aryloxycarbonyl group (namely, esters), compounds in which the carboxyl group has been converted to a haloformyl group (namely, acid halides), and compounds in which the carboxyl group has been converted to an acyloxycarbonyl group (namely, acid anhydrides). Examples of polymerizable derivatives of the compounds having a hydroxyl group such as the aromatic hydroxycarboxylic acids, aromatic diols and aromatic hydroxyamines include compounds in which the hydroxyl group has been acylated and converted to an acyloxy group (namely, acylated compounds). Examples of polymerizable derivatives of the compounds having an amino group such as the aromatic hydroxyamines and aromatic diamines include compounds in which the amino group has been acylated and converted to an acylamino group (namely, acylated compounds).

The liquid crystal polyester according to the present invention preferably has a repeating unit represented by formula (1) shown below (hereinafter sometimes referred to as “the repeating unit (1)”), and more preferably has the repeating unit (1), a repeating unit represented by formula (2) shown below (hereinafter sometimes referred to as “the repeating unit (2)”), and a repeating unit represented by formula (3) shown below (hereinafter sometimes referred to as “the repeating unit (3)”).

—O—Ar¹—CO— (1)

—CO—Ar²—CO— (2)

—X—Ar³—Y— (3)

(In formula (1) to formula (3), Ar¹ represents a phenylene group, a naphthylene group, or a biphenylylene group; each of Ar² and Ar³ independently represents a phenylene group, a naphthylene group, a biphenylylene group, or a group represented by formula (4) shown below;

each of X and Y independently represents an oxygen atom or an imino group (—NH—); and

hydrogen atoms in a group represented by Ar¹, Ar² or Ar³ may each be independently substituted with a halogen atom, an alkyl group of 1 to 10 carbon atoms or an aryl group of 6 to 20 carbon atoms.)

—Ar⁴—Z—Ar⁵— (4)

(In formula (4), each of Ar⁴ and Ar⁵ independently represents a phenylene group or a naphthylene group; and Z represents an oxygen atom, sulfur atom, carbonyl group, sulfonyl group or alkylidene group of 1 to 10 carbon atoms.

Hydrogen atoms in a group represented by Ar⁴ or Ar⁵ may each be independently substituted with a halogen atom, an alkyl group of 1 to 10 carbon atoms or an aryl group of 6 to 20 carbon atoms.)

Examples of the halogen atom include a fluorine atom, chlorine atom, bromine atom and iodine atom.

Examples of the alkyl group of 1 to 10 carbon atoms include a methyl group, ethyl group, n-propyl group, isopropyl group, n-butyl group, isobutyl group, sec-butyl group, tert-butyl group, n-hexyl group, 2-ethylhexyl group, n-octyl group and n-decyl group.

Examples of the aryl group of 6 to 20 carbon atoms include a phenyl group, o-tolyl group, m-tolyl group, p-tolyl group, 1-naphthyl group and 2-naphthyl group.

In those cases where a hydrogen atom in the group represented by Ar¹, Ar² or Ar³ is substituted by a halogen atom, an alkyl group of 1 to 10 carbon atoms or an aryl group of 6 to 20 carbon atoms, the number of groups which substitute a hydrogen atom in each group represented by Ar¹, Ar² or Ar³ is, independently, preferably not more than two, and is more preferably one.

Examples of the alkylidene group of 1 to 10 carbon atoms include a methylene group, ethylidene group, isopropylidene group, n-butylidene group and 2-ethylhexylidene group.

In those cases where a hydrogen atom in the group represented by Ar⁴ or Ar⁵ is substituted by a halogen atom, an alkyl group of 1 to 10 carbon atoms or an aryl group of 6 to 20 carbon atoms, the number of groups which substitute a hydrogen atom in each group represented by Ar⁴ or Ar⁵ is, independently, preferably not more than two, and is more preferably one.

The repeating unit (1) is a repeating unit derived from a specific aromatic hydroxycarboxylic acid. The repeating unit (1) is preferably a repeating unit derived from p-hydroxybenzoic acid (namely, where Ar¹ is a p-phenylene group) or a repeating unit derived from 6-hydroxy-2-naphthoic acid (namely, where Ar¹ is a 2,6-naphthylene group).

The repeating unit (2) is a repeating unit derived from a specific aromatic dicarboxylic acid. The repeating unit (2) is preferably a repeating unit in which Ar² is a p-phenylene group (for example, a repeating unit derived from terephthalic acid), a repeating unit in which Ar² is an m-phenylene group (for example, a repeating unit derived from isophthalic acid), or a repeating unit in which Ar² is a 2,6-naphthylene group (for example, a repeating unit derived from 2,6-naphthalenedicarboxylic acid).

The repeating unit (3) is a repeating unit derived from a specific aromatic diol, aromatic hydroxylamine or aromatic diamine. The repeating unit (3) is preferably a repeating unit in which Ar³ is a p-phenylene group (for example, a repeating unit derived from hydroquinone, p-aminophenol or p-phenylenediamine), or a repeating unit in which Ar³ is a 4,4′-biphenylylene group (for example, a repeating unit derived from 4,4′-dihydroxybiphenyl, 4-amino-4′-hydroxybiphenyl or 4,4′-diaminobiphenyl).

In this description, “derived” means a change in the chemical structure due to polymerization.

In those cases where the liquid crystal polyester according to the present invention includes the repeating unit (1), the repeating unit (2) and the repeating unit (3), the amount of the repeating unit (1), when the total of the repeating unit (1), the repeating unit (2) and the repeating unit (3) is deemed to be 100 mol %, is preferably at least 30 mol %, more preferably at least 30 mol % but not more than 80 mol %, even more preferably at least 40 mol % but not more than 70 mol %, and even more preferably at least 45 mol % but not more than 65 mol %.

Similarly, the amount of the repeating unit (2), when the total of the repeating unit (1), the repeating unit (2) and the repeating unit (3) in the liquid crystal polyester is deemed to be 100 mol %, is preferably not more than 35 mol %, more preferably at least 10 mol % but not more than 35 mol %, even more preferably at least 15 mol % but not more than 30 mol %, and even more preferably at least 17.5 mol % but not more than 27.5 mol %.

Similarly, the amount of the repeating unit (3), when the total of the repeating unit (1), the repeating unit (2) and the repeating unit (3) in the liquid crystal polyester is deemed to be 100 mol %, is preferably not more than 35 mol %, more preferably at least 10 mol % but not more than 35 mol %, even more preferably at least 15 mol % but not more than 30 mol %, and even more preferably at least 17.5 mol % but not more than 27.5 mol %.

Provided the amount of the repeating unit (1) falls within the above range, the melt fluidity, the heat resistance, and the strength and rigidity of the liquid crystal polyester can be more easily improved.

The ratio between the amount of the repeating unit (2) and the amount of the repeating unit (3), when represented by [amount of repeating unit (2)]/[amount of repeating unit (3)] (mol/mol), is preferably from 0.9/1 to 1/0.9, more preferably from 0.95/1 to 1/0.95, and even more preferably from 0.98/1 to 1/0.98.

The liquid crystal polyester according to the present invention may have two or more types of each of the repeating units (1) to (3). Further, the liquid crystal polyester may have other repeating units besides the repeating units (1) to (3), but the amount of those other repeating units, when the total amount of all the repeating units that constitute the liquid crystal polyester is deemed to be 100 mol %, is preferably at least 0 mol % but not more than 10 mol %, and more preferably at least 0 mol % but not more than 5 mol %.

In another aspect, in the liquid crystal polyester according to the present invention, the amount of at least one repeating unit selected from the group consisting of the repeating units (1) to (3), when the total amount of all the repeating units that constitute the liquid crystal polyester is deemed to be 100 mol %, is preferably at least 90 mol % but not more than 100 mol %, and more preferably at least 95 mol % but not more than 100 mol %.

In order to lower the melt viscosity of the liquid crystal polyester according to the present invention, it is preferable that X and Y in the repeating unit (3) both represent oxygen atoms (namely, a repeating unit derived from an aromatic diol). Because the melt viscosity of the liquid crystal polyester can be lowered by increasing the amount of the repeating unit (3) in which X and Y are both oxygen atoms, the melt viscosity of the liquid crystal polyester can be altered as required by controlling the amount of the repeating unit (3) in which X and Y are both oxygen atoms.

In one aspect of a method for producing the liquid crystal polyester according to the present invention, in order to enable a high-molecular weight liquid crystal polyester having superior heat resistance, strength and rigidity to be produced with good operability, it is preferable that the liquid crystal polyester is produced by performing a melt polymerization of the raw material monomers corresponding with the repeating units that constitute the liquid crystal polyester, and subjecting the thus obtained polymer (hereinafter sometimes referred to as a prepolymer) to a solid phase polymerization. The melt polymerization may be performed in the presence of a catalyst. Examples of this catalyst include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino)pyridine and 1-methylimidazole, and of these, nitrogen-containing heterocyclic compounds are preferable.

The flow starting temperature of the liquid crystal polyester according to the present invention is preferably from 270° C. to 400° C., and more preferably from 280° C. to 380° C. When the flow starting temperature falls within this type of range, the fluidity of the liquid crystal polyester is more favorable, and the heat resistance (for example, the solder resistance or blister resistance in those cases where the molded article is an electronic component connector such as a CPU socket) also improves. Further, thermal degradation when melt molding is performed during production of the molded article from the liquid crystal polyester is better suppressed.

The “flow starting temperature” is also referred to as the flow temperature or the fluidizing temperature, and is the temperature that yields a viscosity of 4,800 Pa·s (48,000 poise) when the liquid crystal polyester is melted by heating at a rate of temperature increase of 4° C/minute under a load of 9.8 MPa (100 kg/cm²) using a capillary rheometer, and extruded from a nozzle having an inner diameter of 1 mm and a length of 10 mm, and is a temperature that acts as an indicator of the molecular weight of the liquid crystal polyester (see Naoyuki Koide (ed.), “Liquid Crystal Polymers—Synthesis, Molding, Applications”, CMC Publishing Co., Ltd., Jun. 5, 1987, p. 95).

A single type of the liquid crystal polyester may be used alone, or a combination of two or more types may be used. When two or more types are used, the combination and ratio between the components may set as desired.

The amount of the liquid crystal polyester according to the present invention relative to the total mass of the liquid crystal polyester composition is preferably from 40 to 90% by mass.

### «Glass Fiber»

The glass fiber in the liquid crystal polyester composition that represents one embodiment of the present invention includes the glass fiber (1) having a number average fiber diameter of at least 15 μm but not more than 25 μm, and the glass fiber (2) having a number average fiber diameter of at least 10 μm but not more than 12 μm.

In another aspect, the glass fiber is preferably composed solely of the glass fiber (1) having a number average fiber diameter of at least 15 μm but not more than 25 μm, and the glass fiber (2) having a number average fiber diameter of at least 10 μm but not more than 12 μm.

The number average fiber diameter of the glass fiber (1) is preferably at least 16 μm but not more than 24 μm.

The number average fiber diameter of the glass fiber (2) is preferably at least 10.5 μm but not more than 11.5 μm.

By ensuring that the number average fiber diameters of the glass fibers in the liquid crystal polyester composition have these types of sizes, the molded article obtained by molding the liquid crystal polyester composition is resistant to deformation, and cracking in the molded article can be suppressed. In other words, by including glass fibers having number average fiber diameters that fall within the above ranges, a liquid crystal polyester composition can be provided that can be molded to form a molded article for which the occurrence of cracking is suppressed. Further, by using a combination of the glass fiber (1) and the glass fiber (2), the fluidity of the liquid crystal polyester composition improves, and therefore the filling properties of the liquid crystal polyester composition also improve. As a result, when a molded article is formed by molding the liquid crystal polyester composition, warping of the molded article can be reduced.

Examples of the glass fibers used in the present embodiment include glass fibers produced by all manner of methods, including chopped glass fibers and milled glass fibers. [0041]

Further, the number average fiber length of the glass fiber according to the present invention is preferably greater than 200 μm but less than 600 μm. Furthermore, the number average fiber length is more preferably greater than 350 μm but not more than 500 μm.

In the present embodiment, the number average fiber diameter and the number average fiber length of the glass fibers may be combined as desired.

The number average fiber diameter and the number average fiber length can be measured by observation using a microscope such as a digital microscope. A specific method is described below.

First, 1.0 g of the resin composition is placed in a crucible and incinerated by heating at 600° C. for 4 hours in an electric furnace, thus obtaining a residue containing the glass fibers. That residue is dispersed in ethylene glycol, the dispersion is spread onto a slide glass, and a microscope photograph is taken. Subsequently, in a projected image of the glass fibers, obtained from the microscope photograph by projection along the line of sight, the length along the lengthwise direction is read as the fiber length, and the length in the direction orthogonal to the lengthwise direction is read as the fiber diameter, and the number average fiber length and the number average fiber diameter are determined by calculating the arithmetic mean of the read values. When calculating the arithmetic mean, a sample size of 400 is used.

The glass fibers (1) and (2) may have been treated with a conventional surface treatment agent (for example, a silane-based coupling agent or a titanate-based coupling agent or the like).

In the liquid crystal polyester composition that represents one embodiment of the present invention, the total amount of the glass fiber (1) and the glass fiber (2) is preferably at least 20 parts by mass but not more than 65 parts by mass, more preferably at least 30 parts by mass but not more than 60 parts by mass, and particularly preferably at least 32 parts by mass but not more than 55 parts by mass, per 100 parts by mass of the liquid crystal polyester described above.

In another aspect, the total amount of the glass fiber (1) and the glass fiber (2) may be at least 36.4 parts by mass but not more than 50 parts by mass per 100 parts by mass of the liquid crystal polyester described above.

The ratio between the amount of the glass fiber (1) and the amount of the glass fiber (2), when represented by [amount of glass fiber (1)]/[amount of glass fiber (2)] (parts by mass/parts by mass), is preferably from 0.5/4 to 4/0.5, more preferably from 1/4 to 4/1, even more preferably from 0.9/3.5 to 3.5/0.9, and particularly preferably from 0.95/3.2 to 3.2/0.95.

In another aspect, [amount of glass fiber (1)]/[amount of glass fiber (2)] (parts by mass/parts by mass) is preferably from 1/3 to 2/1.

By ensuring that the ratio between the amount of the glass fiber (1) and the amount of the glass fiber (2) falls within the above range, the occurrence of cracking of a molded article obtained by molding the liquid crystal polyester composition can be suppressed, and warping of the molded article can also be suppressed.

From the viewpoint of the flexural strength of the molded article, it is preferable either that the amount of the glass fiber (1) and the amount of the glass fiber (2) are equal, or that the amount of the glass fiber (1) is less than the amount of the glass fiber (2). Specifically, the ratio between the amount of the glass fiber (1) and the amount of the glass fiber (2), when represented by [amount of glass fiber (1)]/[amount of glass fiber (2)] (parts by mass/parts by mass), is preferably from 1/1 to 1/4, more preferably from 1/1 to 1/3, and even more preferably from 1/1 to 1/2.

In the liquid crystal polyester composition of the present invention, the amount of glass fiber is preferably from 9 to 41% by mass relative to the total mass of the liquid crystal polyester composition.

Further, the total amount of the glass fiber (1) and the glass fiber (2) is preferably from 9 to 41% by mass relative to the total mass of the liquid crystal polyester composition.

The glass fiber according to the liquid crystal polyester composition that represents one embodiment of the present invention may include other glass fiber besides the glass fiber (1) and the glass fiber (2), and examples of the other glass fiber include flat glass fiber. Here, “flat glass fiber” means flat glass fiber in which the fiber cross-sectional shape is not circular, but rather an oval shape, elliptical shape, rectangular shape, rectangular shape in which both short sides are semicircular, or ovaloid shape.

Generally, when glass fiber having a long fiber length is included in a liquid crystal polyester composition, the glass fiber tends to break easily during molding, and the occurrence of cracking in molded articles molded from the liquid crystal polyester composition has been unable to be suppressed.

In contrast, because the liquid crystal polyester composition that represents one embodiment of the present invention uses a combination of the glass fiber (1) having a large average fiber diameter and the glass fiber (2) having a narrower average fiber diameter, the glass fiber is unlikely to break during molding, which contributes to a reduction in the occurrence of cracking in the molded article.

The liquid crystal polyester composition of the present embodiment can also be obtained by producing master batch pellets by blending the liquid crystal polyester and glass fibers according to the present invention, and then dry-blending these master batch pellets with pellets that do not contain the glass fibers at the time of molding. In this case, the amounts of the glass fibers following dry-blending should satisfy the prescribed amounts described above.

Alternatively, master batch pellets may be produced by blending the liquid crystal polyester and the glass fiber (1), and blending the liquid crystal polyester and the glass fiber (2).

### «Other Components»

### [Plate-Like Filler]

The liquid crystal polyester composition of the present embodiment preferably also contains a plate-like filler, provided the effects of the present invention are not impaired.

Examples of the plate-like filler include at least one plate-like filler selected from the group consisting of talc, mica, graphite, wollastonite, glass flakes, barium sulfate and calcium carbonate. Among these, one or both of talc and mica is preferable, and a talc is more preferable.

From the viewpoint of improving the crack resistance of molded articles obtained by molding the liquid crystal polyester composition, the volume average particle diameter of the plate-like filler included in the liquid crystal polyester composition of the present embodiment is preferably at least 15 μm but not more than 40 μm, more preferably at least 20 μm but not more than 30 μm, and particularly preferably at least 22 μm but not more than 28 μm.

Provided the volume average particle diameter of the plate-like filler is at least as large as the above lower limit, the crack resistance of the molded article tends to improve further. Furthermore, provided the volume average particle diameter of the plate-like filler is not more than the above upper limit, the occurrence of warping before and after reflow can be suppressed.

The volume average particle diameter of the plate-like filler can be determined by a laser diffraction method, and specifically, can be determined under the following conditions.

Measurement Conditions

Measurement apparatus: laser diffraction/scattering particle size distribution analyzer (LA-950V2, manufactured by Horiba, Ltd.)

Particle refractive index: 1.53-0.1i

Dispersion medium: water

Dispersion medium refractive index: 1.33

Because the volume average particle diameter of the plate-like filler undergoes no substantial change in the melt kneading described below, the volume average particle diameter of the plate-like filler can be determined by measuring the volume average particle diameter of the plate-like filler prior to incorporation in the liquid crystal polyester composition.

The liquid crystal polyester composition of the present embodiment preferably contains the plate-like filler in an amount which, when the amount of the liquid crystal polyester according to the present invention is deemed to be 100 parts by mass, is at least 10 parts by mass but not more than 50 parts by mass, more preferably at least 12 parts by mass but not more than 48 parts by mass, and even more preferably at least 14 parts by mass but not more than 47 parts by mass. Further, in another aspect, when the liquid crystal polyester composition of the present invention contains a plate-like filler, the amount of the plate-like filler is preferably from 10 to 33% by mass relative to the total mass of the liquid crystal polyester composition.

### [Fibrous Filler]

The liquid crystal polyester composition of the present invention may also contain a fibrous filler other than the glass fibers described above.

Either one or both of a fibrous inorganic filler and a fibrous organic filler may be used as the fibrous filler. Examples of the fibrous inorganic filler include carbon fiber such as PAN-based carbon fiber and pitch-based carbon fiber; ceramic fiber such as silica fiber, alumina fiber and silica-alumina fiber; metal fiber such as stainless steel fiber; and whiskers such as potassium titanate whiskers, barium titanate whiskers, wollastonite whiskers, aluminum borate whiskers, silicon nitride whiskers and silicon carbide whiskers.

Examples of the fibrous organic filler include polyester fiber and aramid fiber.

Among these, at least one fibrous filler selected from the group consisting of potassium titanate whiskers, wollastonite whiskers and aluminum borate whiskers is preferable.

These fillers may have been treated with a conventional surface treatment agent (for example, a silane-based coupling agent or a titanate-based coupling agent or the like).

The amount of the fibrous filler, when the amount of the liquid crystal polyester according to the present invention is deemed to be 100 parts by mass, is preferably at least 0 parts by mass but not more than 100 parts by mass.

In another aspect, when the liquid crystal polyester composition of the present invention contains a fibrous filler, the amount of the fibrous filler is preferably from 0 to 50% by mass relative to the total mass of the liquid crystal polyester composition.

In the liquid crystal polyester composition of the present embodiment, when the amount of the liquid crystal polyester is deemed to be 100 parts by mass, provided the total amount of the glass fiber and the plate-like filler is at least 65 parts by mass, the occurrence of cracking in the molded articles obtained by molding the liquid crystal polyester composition is suppressed, whereas provided this total amount is not more than 100 parts by mass, the fluidity of the liquid crystal polyester composition is satisfactory.

### [Particulate Filler]

The liquid crystal polyester composition of the present embodiment may also contain a particulate filler, provided the effects of the present invention are not impaired.

Examples of the particulate filler include silica, alumina, titanium oxide, boron nitride, silicon carbide and calcium carbonate.

### (Other Optional Components)

The liquid crystal polyester composition of the present invention may also contain other components that correspond with none of the glass fiber, the plate-like filler, the particulate filler or the liquid crystal polyester, provided the effects of the present invention are not impaired.

Examples of these other components include typical additives such as releasability improvers such as fluororesins and metal soaps; colorants such as dyes and pigments; antioxidants; thermal stabilizers; ultraviolet absorbers; antistatic agents; and surfactants. A carbon black is preferable as the colorant.

Further, more examples of these other components include components having an external lubricant effect such as higher fatty acids, higher fatty acid esters, metal salts of higher fatty acids, and fluorocarbon-based surfactants.

Furthermore, yet more examples of these other components include thermoplastic resins such as polyamides, polyesters other than liquid crystal polyesters, polyphenylene sulfides, polyetherketones, polycarbonates, polyphenylene ethers and modified products thereof, polysulfones, polyethersulfones and polyetherimides; and thermosetting resins such as phenol resins, epoxy resins and polyimide resins.

The amount of the above other components, when the amount of the liquid crystal polyester of the present embodiment is deemed to be 100 parts by mass, is preferably at least 0 parts by mass but not more than 5 parts by mass.

In another aspect, in those cases where the liquid crystal polyester composition of the present invention contains other components, the amount of those other components is preferably from 0 to 5% by mass relative to the total mass of the liquid crystal polyester composition.

In one aspect of the liquid crystal polyester composition of the present invention, the total amount of the glass fibers, the plate-like filler, the particulate filler and the liquid crystal polyester is preferably at least 35% by mass but not more than 100% by mass, and more preferably at least 45% by mass but not more than 100% by mass, relative to the total mass of the liquid crystal polyester composition, and the composition may be composed solely of the glass fibers, the plate-like filler, the particulate filler and the liquid crystal polyester. By ensuring the above total amount is at least as large as the lower limit, the fluidity during molding is superior, and the resistance to cracking of the molded article can be further improved.

The liquid crystal polyester composition of the present invention can be produced by blending the raw material components, and there are no particular limitations on the blending method used. For example, a method may be used in which the glass fibers and the liquid crystal polyester, and if desired at least one component selected from the group consisting of the plate-like filler, the particulate filler and the above other components, are each supplied individually to a melt kneader. Further, these raw material components may first be subjected to preliminary mixing using a mortar, Henschel mixer, ball mill, or ribbon blender or the like, and subsequently supplied to a melt kneader. Furthermore, in another aspect, pellets produced by melt kneading of the liquid crystal polyester and the glass fibers, pellets produced by melt kneading of the liquid crystal polyester and the plate-like filler, and pellets produced by melt kneading of the liquid crystal polyester and the particulate filler may be mixed together in the desired blend ratio. A glass fiber that has been coated or bundled with a thermoplastic resin such as a urethane resin, acrylic resin or ethylene/vinyl acetate copolymer, or with a thermosetting resin such as an epoxy resin may also be used.

In yet another aspect, pellets produced by melt kneading of the liquid crystal polyester and the glass fiber (1), pellets produced by melt kneading of the liquid crystal polyester and the glass fiber (2), pellets produced by melt kneading of the liquid crystal polyester and the plate-like filler, and pellets produced by melt kneading of the liquid crystal polyester and the particulate filler may be mixed together in the desired blend ratio.

The melt extruder is preferably a device having a cylinder, one or more screws disposed inside the cylinder, and one or more supply ports provided on the cylinder, and is more preferably a device that also has one or more vents in the cylinder.

Examples of methods for supplying the raw materials include a method in which the glass fibers of different length are blended together in advance and then supplied to the melt kneader, and a method in which one glass fiber is supplied from a supply port at the drive side of the melt kneader together with the liquid crystal polyester, and the other glass fiber is supplied from a central supply port.

Examples of the glass fibers of different length include a combination of milled glass fiber and chopped glass fiber, and a specific example is a combination of a milled glass fiber having a fiber length of 30 to 150 μm, and a chopped glass fiber having a fiber length of 3 to 4 mm. Further, pellets of a liquid crystal polyester composition containing a milled glass fiber and pellets of a liquid crystal polyester composition containing a chopped glass fiber may be blended in advance and then supplied to a melt extruder, or one of the above pellets may be supplied from a supply port at the drive side of the melt kneader together with the liquid crystal polyester, while the other pellets are supplied from a central supply port.

### <Molded Article>

A second aspect of the present invention is a molded article obtained by molding the liquid crystal polyester composition of the first aspect of the present invention described above.

The liquid crystal polyester composition exhibits excellent fluidity during molding, and is ideal for producing a molded article having superior mechanical strength. The method used for producing the molded article may be a conventional method such as an injection molding method.

The molded article of this embodiment is preferably a connector. A connector obtained by molding the liquid crystal polyester composition described above exhibits superior resistance to cracking, even when the wall thickness is thin.

Further, the connector is preferably a CPU socket.

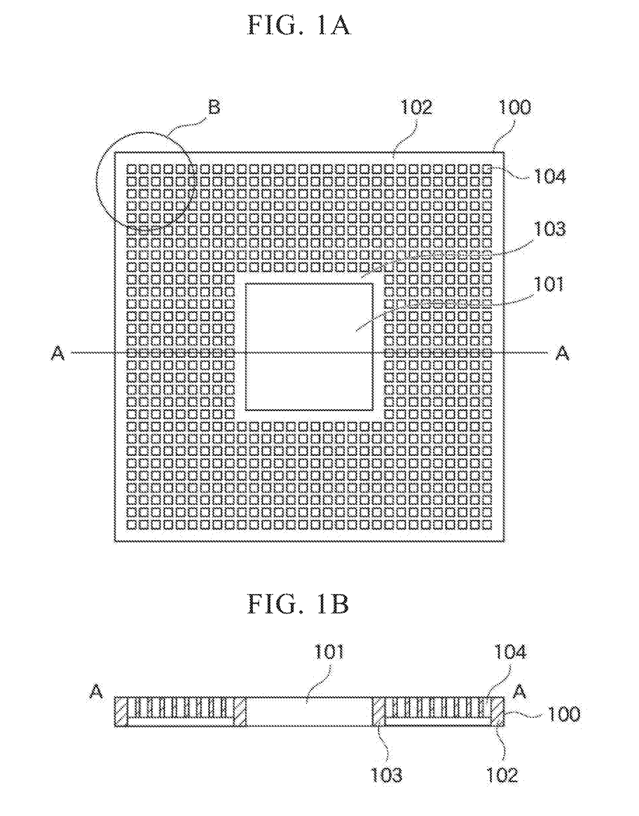

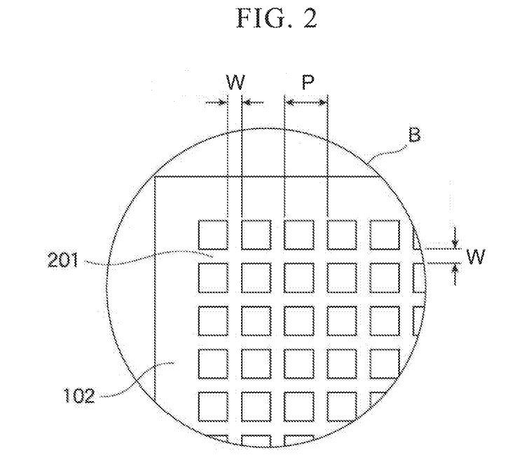

FIG. 1A is a schematic plan view illustrating a connector molded from the liquid crystal polyester composition described above, and FIG. 1B is a cross-sectional view along the line A-A in FIG. 1A. Further, FIG. 2 is an enlarged view of the region B in FIG. 1A.

The connector 100 illustrated in these figures is a CPU socket, which has a square plate-like form when viewed in plan view, and has a square opening 101 in the center. The outer peripheral portion and the inner peripheral portion of the connector 100 are formed with the back surface protruding, thus forming an outer frame 102 and an inner frame 103 respectively. Further, 794 pin insertion holes 104 each having a square shape in horizontal cross-section are provided in a matrix-like arrangement in the region sandwiched between the outer frame 102 and the inner frame 103. In this manner, the portions that separate the pin insertion holes 104, namely the minimum wall thickness portions 201, form an overall lattice shape.

The dimensions of the connector 100 in the field of view illustrated in FIG. 1A may be set as desired in accordance with the intended purpose, and for example, the external dimensions may be 42 mm×42 mm, with the dimensions of the opening 101 being 14 mm×14 mm.

Further, the thickness of the connector 100 in the field of view of FIG. 1B is 4 mm at the outer frame 102 and the inner frame 103, and 3 mm in the region sandwiched therebetween (namely, the thickness of the minimum wall thickness portions 201 in the enlarged view of FIG. 2). The cross-sectional dimensions of each of the pin insertion holes 104 in FIG. 1A or FIG. 1B are 0.7 mm×0.7 mm, and the pitch P illustrated in the enlarged view of FIG. 2 (the sum of the cross-sectional width of one pin insertion hole 104 and the minimum distance between adjacent pin insertion holes 104) is 1 mm.

Furthermore, the width W of the minimum wall thickness portions 201 illustrated in the enlarged view of FIG. 2 (the lattice wall thickness, namely the shortest distance between adjacent pin insertion holes 104) is 0.2 mm.

The dimensions described here are merely examples, and the number of the pin insertion holes 104 may also be set as desired in accordance with the intended purpose.

For example, in one aspect, the connector may have external dimensions from 40 mm×40 mm to 100 mm×100 mm, and the dimensions of the opening may be from 10 mm×10 mm to 40 mm×40 mm. The thickness of the connector may be from 2 mm to 6 mm at the outer frame and the inner frame, and may be from 2 to 5 mm in the region sandwiched therebetween (namely, the thickness of the minimum wall thickness portions). The cross-sectional dimension of each of the pin insertion holes in the connector may be from 0.2 to 0.5 mm, the pitch P may be from 0.8 to 1.5 mm, and the width of the minimum wall thickness portions may be from 0.1 to 0.4 mm.

When the connector 100 is produced by an injection molding method, the conditions include, for example, a molding temperature of 300 to 400° C., an injection speed of 100 to 300 mm/second, and an injection peak pressure of 50 to 150 MPa.

In other words, one aspect of the method for producing a molded article of the present invention comprises:

a step of obtaining a liquid crystal polyester composition by melt kneading a liquid crystal polyester, a glass fiber and, if desired, at least one component selected from the group consisting of plate-like fillers, particulate fillers and other components, and

a step of subjecting the obtained liquid crystal polyester composition to injection molding under conditions including a molding temperature of 300 to 400° C., an injection speed of 100 to 300 mm/second, and an injection peak pressure of 50 to 150 MPa, wherein

the amount of the glass fiber in the liquid crystal polyester composition is at least 10 parts by mass but not more than 70 parts by mass per 100 parts by mass of the liquid crystal polyester, and

the glass fiber comprises a glass fiber (1) having a number average fiber diameter of at least 15 μm but not more than 25 μm and a glass fiber (2) having a number average fiber diameter of at least 10 μm but not more than 12 μm.

In another aspect, the step of obtaining the liquid crystal polyester composition may be a step of obtaining the liquid crystal polyester composition by mixing pellets produced by melt kneading of the liquid crystal polyester and the glass fiber (1), pellets produced by melt kneading of the liquid crystal polyester and the glass fiber (2), and, if desired, pellets produced by melt kneading of the liquid crystal polyester and at least one component selected from the group consisting of plate-like fillers, particulate fillers and other components.

The molded article molded from the liquid crystal polyester composition of the present invention described above is resistant to deformation under high-temperature conditions. Accordingly, the molded article obtained by molding the liquid crystal polyester composition of the present invention has improved resistance to cracking, meaning the occurrence of cracking can be suppressed.

As a result, a connector obtained by molding the liquid crystal polyester composition described above is unlikely to suffer from cracking, even in the minimum wall thickness portions W illustrated in FIG. 2.

As described above, with a molded article obtained by molding the liquid crystal polyester composition of the present invention, the occurrence of cracking can be suppressed. Accordingly, by using a liquid crystal polyester composition of the present invention, even a molded article other than the connector or CPU socket described above that has a thin-walled portion within a portion of the molded article can be molded favorably.

Another aspect of the liquid crystal polyester composition of the present invention is:

a liquid crystal polyester composition comprising a liquid crystal polyester, a glass fiber, a plate-like filler and, if desired, at least one component selected from the group consisting of fibrous fillers, particulate fillers and other components; wherein

the liquid crystal polyester comprises:

a repeating unit derived from p-hydroxybenzoic acid,

a repeating unit derived from terephthalic acid, and

a repeating unit derived from 4,4′-dihydroxybiphenyl;

the glass fiber comprises:

a glass fiber (1) having a number average fiber diameter of at least 15 μm but not more than 25 μm, preferably at least 16 μm but not more than 24 μm, and more preferably 17 μm to 23 μm, and

a glass fiber (2) having a number average fiber diameter of at least 10 μm but not more than 12 μm, preferably at least 10.5 μm but not more than 11.5 μm, and more preferably 11 μm; and

the amount of the glass fiber is at least 10 parts by mass but not more than 70 parts by mass, preferably at least 20 parts by mass but not more than 65 parts by mass, more preferably at least 30 parts by mass but not more than 60 parts by mass, even more preferably at least 32 parts by mass but not more than 55 parts by mass, and particularly preferably at least 36.4 parts by mass but not more than 50 parts by mass, per 100 parts by mass of the liquid crystal polyester.

In another aspect, the amount of the glass fiber in the above liquid crystal polyester composition may be 36.4 parts by mass or 50 parts by mass.

In yet another aspect, the above plate-like filler may be a talc.

### EXAMPLES

The present invention is described below in further detail using a series of examples, but the present invention is in no way limited by the following examples.

### Production Example 1

### Method for Producing Liquid Crystal Polyester 1

A reactor fitted with a stirring device, a torque meter, a nitrogen gas introduction tube, a thermometer and a reflux condenser was charged with 994.5 g (7.2 mol) of p-hydroxybenzoic acid, 299.1 g (1.8 mol) of terephthalic acid, 99.7 g (0.6 mol) of isophthalic acid, 446.9 g (2.4 mol) of 4,4′-dihydroxybiphenyl, 1,347.6 (13.2 mol) of acetic anhydride, and 0.2 g of 1-methylimidazole, the contents were stirred under a stream of nitrogen gas while the temperature was raised from room temperature to 150° C. over a period of 30 minutes, and were then refluxed at 150° C. for one hour. Subsequently, 0.9 g of 1-methylimidazole was added, the temperature was raised to 320° C. over a period of 2 hours and 50 minutes while by-product acetic acid and unreacted acetic anhydride were removed by distillation, the temperature was held at 320° C. until an increase in torque was confirmed, and the contents were then removed from the reactor and cooled to room temperature. The obtained solid was then crushed using a crusher, thus obtaining a powdered prepolymer. Subsequently, this prepolymer was heated, under an atmosphere of nitrogen gas, from room temperature to 250° C. over a period of one hour and then from 250° C. to 285° C. over a period of 5 hours, and was then held at 285° C. for 3 hours to effect a solid phase polymerization, before being cooled to obtain a powdered liquid crystal polyester 1. The flow starting temperature of this liquid crystal polyester 1 was 327° C.

In this description, room temperature is from 20 to 25° C.

### Examples 1 to 5, Comparative Examples 1 to 3

The liquid crystal polyester 1 obtained in the above production example 1, glass fibers, and talc were melt kneaded and pelletized at 340° C. in the proportions shown in Table 1 or Table 2 using a twin-screw extruder (PCM-30HS, manufactured by Ikegai, Ltd., screw rotation: same direction, L/D=44).

The thus obtained pellets were injection molded using an injection molding machine (ROBOSHOT S-2000i 30B, manufactured by FANUC Corporation), under molding conditions including a cylinder temperature of 370° C. and a mold temperature of 130° C., thus obtaining a 1021 pin-compatible model CPU socket molded article.

### (Measurement of Molded Article Cracking)

Cracking of the model CPU socket molded articles of Examples 1 to 5 and Comparative Examples 1 to 3 obtained using the method described above was measured using the following method.

First, five molded articles (1021 pin-compatible model CPU sockets) were prepared for each of the Examples 1 to 5 and Comparative Examples 1 to 3 obtained using the method described above, and a heat history was imparted to the five molded articles by heating the articles at 260° C. for 4 minutes and 40 seconds using an oven (DN63H, manufactured by Yamato Scientific Co., Ltd.). These temperature conditions represent the assumed temperature conditions for the reflow step when producing an electronic device using the CPU socket.

Following cooling of the molded articles to room temperature, a 15-fold zoom stereoscopic microscope (ZMM-45T2, manufactured by Sigma Koki Co., Ltd.) was used to inspect the 5 heated molded article samples, the number of cracks that had occurred in the wall surfaces of each CPU socket was counted, and the total of all the values was deemed the CPU crack count.

### (Measurement of Molded Article Warping)

The warping of model CPU socket molded articles of Examples 1 to 5 and Comparative Examples 1 to 3 obtained using the method described above was measured using the following method.

First, five molded articles (1021 pin-compatible model CPU sockets) were prepared for each of the Examples 1 to 5 and Comparative Examples 1 to 3 obtained using the method described above. For each molded article, a flatness measurement module (manufactured by Cores Corporation) was used to measure the amount of warping at substantially regular intervals along the outer frame and the inner frame. In this measurement of the amount of warping, the least squares plane method was used to calculate an average value for the obtained amounts of warping (5 sets of data for each molded article), and this average value was deemed the amount of warping before reflow for the molded article. The same connector molded articles were then held at 50° C. for 40 seconds, heated to 270° C., and then held at that temperature for one minute. Subsequently, the heat treatment was completed by cooling the temperature to 50° C., the amount of warping of these connector molded articles after heat treatment was measured in the same manner as above, and the average value for the amount of warping was calculated and deemed the amount of warping after reflow.

The amount of warping is preferably as small as possible.

The amount of warping determined by the least squares plane method means the value obtained by determining the least squares plane from the three-dimensional measurement data measured along the outer frame and the inner frame by the flatness measurement module, defining that reference plane as representing an amount of warping of 0, and then determining the maximum value for warping from that reference plane.

### (Measurement of Flexural Strength)

Using an injection molding machine (PS40E5ASE, manufactured by Nissei Plastic Industrial Co., Ltd.) under conditions including a cylinder temperature of 360° C., a mold temperature of 150° C. and an injection speed of 60 mm/second, a rod-shaped test piece having a width of 12.7 mm, a length of 127 rum and a thickness of 6.4 mm was molded from the obtained pellets, and the flexural strength at room temperature was measured by performing the flexural test prescribed in ASTM D790.

TABLE 1

| | | Example | Example | Example | Comparative | Comparative |
|---|---|---|---|---|---|---|
| | | 1 | 2 | 3 | Example 1 | Example 2 |
| Liquid crystal polyester | | 60 | 60 | 60 | 60 | 60 |
| Glass | Glass fiber 1 | — | — | — | — | — |
| fiber | (number average fiber | | | | | |
| | diameter: 23 μm) | | | | | |
| | Glass fiber 2 | 10 | 15 | 20 | — | 30 |
| | (number average fiber | | | | | |
| | diameter: 17 μm) | | | | | |
| | Glass fiber 3 | 20 | 15 | 10 | 30 | — |
| | (number average fiber | | | | | |
| | diameter: 11 μm) | | | | | |
| Talc | Talc 1 | 10 | 10 | 10 | 10 | 10 |
| | Talc 2 | — | — | — | — | — |
| CPU cracking (count) | | 0 | 0 | 0 | 7 | 0 |
| CPU | Before reflow (mm) | 0.396 | 0.412 | 0.340 | 0.503 | 0.480 |
| warping | After reflow (mm) | 0.420 | 0.397 | 0.362 | 0.487 | 0.485 |
| Flexural | Measured value (MPa) | 144 | 144 | 136 | 144 | 133 |
| strength | | | | | | |

TABLE 2

| | | Example | Example | Comparative |
|---|---|---|---|---|
| | | 4 | 5 | Example 3 |
| Liquid crystal polyester | | 55 | 55 | 55 |
| Glass | Glass fiber 1 | 5 | 10 | 20 |
| fiber | (number average fiber | | | |
| | diameter: 23 μm) | | | |
| | Glass fiber 2 | — | — | — |
| | (number average fiber | | | |
| | diameter: 17 μm) | | | |
| | Glass fiber 3 | 15 | 10 | — |
| | (number average fiber | | | |
| | diameter: 11 μm) | | | |
| Talc | Talc 1 | — | — | — |
| | Talc 2 | 25 | 25 | 25 |
| CPU cracking (count) | | 0 | 0 | 0 |
| CPU | Before reflow (mm) | 0.220 | 0.168 | 0.284 |
| warping | After reflow (mm) | 0.310 | 0.306 | 0.357 |
| Flexural | Measured value (MPa) | 120 | 118 | 109 |
| strength | | | | |

In Tables 1 and 2, details regarding each of the materials are as follows.

Glass fiber 1: CS03TAFT692, manufactured by Owens Corning Japan Co., Ltd. (number average fiber diameter: 23 μm, chopped strands with a fiber length of 3 mm)

Glass fiber 2: ECS03T-747N, manufactured by Nippon Electric Glass Co., Ltd. (number average fiber diameter: 17 μm, chopped strands with a fiber length of 3 mm)

Glass fiber 3: CS3J-260S, manufactured by Nitto Boseki Co., Ltd. (fiber diameter: 11 μm, chopped strands with a fiber length of 3 mm)

Talc 1: Rose K, manufactured by Nippon Talc Co., Ltd. (volume average particle diameter: 17 μm)

Talc 2: NK-64, manufactured by Fuji Talc Industrial Co., Ltd. (volume average particle diameter: 23 μm)

Based on the results shown in Table 1, it is evident that the CPU sockets obtained in Examples 1 to 3 were favorable molded articles with absolutely no cracking and reduced warping before and after reflow.

Further, the CPU sockets also exhibited satisfactory flexural strength. In contrast, the CPU socket obtained in Comparative Example 1 had numerous cracks. The CPU socket obtained in Comparative Example 2 exhibited no cracking, but had a large amount of warping before and after reflow.

Based on the results shown in Table 2, it is clear that the CPU sockets obtained in Examples 4 and 5 exhibited absolutely no cracking and also displayed reduced warping before and after reflow. The CPU socket obtained in Comparative Example 3 exhibited no cracking, but had a large amount of warping before and after reflow, and also had lower flexural strength.

### INDUSTRIAL APPLICABILITY

The present invention can provide a liquid crystal polyester composition which, when molded into a molded article, is capable of improving the resistance to cracking in the molded article and suppressing warping of the molded article, and can also provide a molded article molded from the liquid crystal polyester composition, and is therefore useful industrially.

### DESCRIPTION OF THE REFERENCE SIGNS

100: Connector
101: Opening
102: Outer frame
103: Inner frame
104: Pin insertion hole
201: Minimum wall thickness portion
P: Pin insertion hole pitch
W: Width of minimum wall thickness portion (thickness of lattice wall)

1. A liquid crystal polyester composition comprising a liquid crystal polyester and a glass fiber, wherein:
an amount of the glass fiber is at least 10 parts by mass but not more than 70 parts by mass per 100 parts by mass of the liquid crystal polyester, and
the glass fiber comprises a glass fiber (1) having a number average fiber diameter of at least 15 μm but not more than 25 μm and a glass fiber (2) having a number average fiber diameter of at least 10 μm but not more than 12 μm.

2. The liquid crystal polyester composition according to claim 1, wherein a ratio between an amount of the glass fiber (1) and an amount of the glass fiber (2), when represented by [amount of glass fiber (1)]/[amount of glass fiber (2)] (parts by mass/parts by mass), is from 1/1 to 1/4.

3. The liquid crystal polyester composition according to claim 1, wherein the liquid crystal polyester comprises a repeating unit represented by formula (1), a repeating unit represented by formula (2), and a repeating unit represented by formula (3):
—O—Ar¹—CO— (1)
—CO—Ar²—CO— (2)
—X—Ar³—Y— (3)
(in formula (1) to formula (3), Ar¹ represents a phenylene group, a naphthylene group, or a biphenylylene group;
each of Ar² and Ar³ independently represents a phenylene group, a naphthylene group, a biphenylylene group, or a group represented by formula (4);
each of X and Y independently represents an oxygen atom or an imino group; and
hydrogen atoms in a group represented by Ar¹, Ar² or Ar³ may each be independently substituted with a halogen atom, an alkyl group of 1 to 10 carbon atoms or an aryl group of 6 to 20 carbon atoms);
—Ar⁴—Z—Ar⁵— (4)
(in formula (4), each of Ar⁴ and Ar⁵ independently represents a phenylene group or a naphthylene group; and Z represents an oxygen atom, sulfur atom, carbonyl group, sulfonyl group or alkylidene group of 1 to 10 carbon atoms).

4. A molded article molded from the liquid crystal polyester composition according to claim 1.

5. The molded article according to claim 4, wherein the molded article is a connector.

6. The molded article according to claim 5, wherein the connector is a CPU socket.
